(19) United States
(12) Patent Application Publication
(10) Pub. No.: US 2006/0099469 A1
(43) Pub. Date: May 11, 2006

(54) Control apparatus to improve start-up time in a PEM fuel cell power module

(76) Inventors: Mark A. Meltser, Pittsford, NY (US); Joe Machuca, Rochester, NY (US); Abdullah B. Alp, Rochester, NY (US); Stephen Farris, Rochester, NY (US)

Correspondence Address: CARY W. BROOKS;General Motors Corporation, Legal Staff, Mail Code 482-C23-B21, P.O. Box 300, Detroit, MI, 48265-3000, US

(21) Appl. No.: 10/982,304

(22) Filed: Nov. 5, 2004

(51) Int. Cl. H01M 8/04

(52) U.S. Cl. 429/24; 429/26; 429/39; 429/13

(57) ABSTRACT

A fuel cell system that uses compressed and heated cathode input air to heat the fuel cell stack at system start-up. The system includes a heat exchanger that uses the system cooling fluid to cool the compressed and heated cathode input air before it is sent to the fuel cell stack. At system start-up, a proportional by-pass valve directs a controlled portion of the cooling fluid around the heat exchanger so that the heated cathode input air can be used to heat the fuel cell stack. Once the stack reaches its operating temperature, the by-pass valve does not by-pass the heat exchanger. The fuel cell system also includes an inlet air valve that is used to choke the compressor at system start-up to cause the compressor to rapidly heat the compressed air.

### BACKGROUND OF THE INVENTION

1. Field of the Invention

This invention relates generally to a fuel cell system and, more particularly, to a fuel cell system that uses compressed and heated cathode input air to heat a fuel cell stack in the system at system start-up.

2. Discussion of the Related Art

Hydrogen is a very attractive fuel because it is clean and can be used to efficiently produce electricity in a fuel cell. The automotive industry expends significant resources in the development of hydrogen fuel cells as a source of power for vehicles. Such vehicles would be more efficient and generate fewer emissions than today's vehicles employing internal combustion engines.

A hydrogen fuel cell is an electrochemical device that includes an anode and a cathode with an electrolyte therebetween. The anode receives hydrogen gas and the cathode receives oxygen or air. The hydrogen gas is disassociated in the anode to generate free hydrogen protons and electrons. The hydrogen protons pass through the electrolyte to the cathode. The hydrogen protons react with the oxygen and the electrons in the cathode to generate water. The electrons from the anode cannot pass through the electrolyte, and thus are directed through a load to perform work before being sent to the cathode. The work acts to operate the vehicle.

Proton exchange membrane fuel cells (PEMFC) are a popular fuel cell for vehicles. The PEMFC generally includes a solid polymer electrolyte proton conducting membrane, such as a perfluorosulfonic acid membrane. The anode and cathode typically include finely divided catalytic particles, usually platinum (Pt), supported on carbon particles and mixed with an ionomer. The catalytic mixture is deposited on opposing sides of the membrane. The combination of the anode catalytic mixture, the cathode catalytic mixture and the membrane define a membrane electrode assembly (MEA). MEAs are relatively expensive to manufacture and require certain conditions for effective operation. These conditions include proper water management and humidification, and control of catalyst poisoning constituents, such as carbon monoxide (CO).

Several fuel cells are typically combined in a fuel cell stack to generate the desired power. For example, a typical fuel cell stack for a vehicle may have two hundred stacked fuel cells. The fuel cell stack receives a cathode input gas, typically a flow of air forced through the stack by a compressor. Not all of the oxygen is consumed by the stack and some of the air is output as a cathode exhaust gas that may include water as a stack by-product. The fuel cell stack also receives an anode hydrogen input gas that flows into the anode side of the stack.

The fuel cell stack includes a series of bipolar plates positioned between the several MEAs in the stack. The bipolar plates include an anode side and a cathode side for adjacent fuel cells in the stack. Anode gas flow channels are provided on the anode side of the bipolar plates that allow the anode gas to flow to the respective MEA. Cathode gas flow channels are provided on the cathode side of the bipolar plates that allow the cathode gas to flow to the respective MEA. The bipolar plates are made of a conductive material, such as stainless steel, so that they conduct the electricity generated by the fuel cells out of the stack. The bipolar plates also include flow channels through which a cooling fluid flows.

It is desirable during certain fuel cell operating conditions, such as fuel cell start-up, low power operation, low ambient temperature operation, etc., to provide supplemental heat to the fuel cells to maintain the desired operating temperature within the fuel cell stack for proper water management and reaction kinetics purposes. Particularly, the MEAs must have a proper relative humidity (RH) and the fuel cells must be within a certain temperature range to operate efficiently.

At cold system start-up before the fuel cell stack has reached its desired operating temperature, the stack is unable to produce enough power to operate the vehicle. Therefore, the vehicle operator must wait a certain period of time until the fuel cell stack reaches its operating temperature before operating the vehicle. Typical fuel cell stacks take about 160 seconds to reach their operating temperature as a result of stack inefficiencies at which time they are able to provide power to operate the vehicle. It would be desirable to provide supplemental heat to quickly increase the temperature of the fuel cell stack at vehicle start-up so that the vehicle operator can immediately operate the vehicle.

### SUMMARY OF THE INVENTION

In accordance with the teachings of the present invention, a fuel cell system is disclosed that uses compressed and heated cathode input air to heat the fuel cell stack at system start-up. The system includes a heat exchanger that uses the system cooling fluid to cool the compressed and heated cathode input air before it is sent to the fuel cell stack. At system start-up, a proportional by-pass valve directs a controlled portion of the cooling fluid around the heat exchanger so that the heated cathode input air can be used to heat the fuel cell stack. Once the stack reaches its operating temperature, the by-pass valve will be used to maintain cathode inlet temperature. The fuel cell system also includes an inlet air valve that is used to choke the compressor at system start-up to cause the compressor to more rapidly heat the compressed air, especially when the ambient air temperature is low.

Additional advantages and features of the present invention will become apparent from the following description and appended claims, taken in conjunction with the accompanying drawings.

### BRIEF DESCRIPTION OF THE DRAWINGS

FIG. 1 is a schematic plan view of a fuel cell system that employs a proportional valve for directing a cooling fluid around a heat exchanger that cools the compressed cathode input air to allow the heated input air to heat the fuel cell stack at system start-up; and

FIG. 2 is a flow chart diagram showing the operation of controlling the proportional valve in the system shown in FIG. 1.

### DETAILED DESCRIPTION OF THE EMBODIMENTS

The following discussion of the embodiments of the invention directed to a technique for using compressed cathode input air to heat a fuel cell stack at system start-up is merely exemplary in nature, and is in no way intended to limit the invention or its applications or uses.

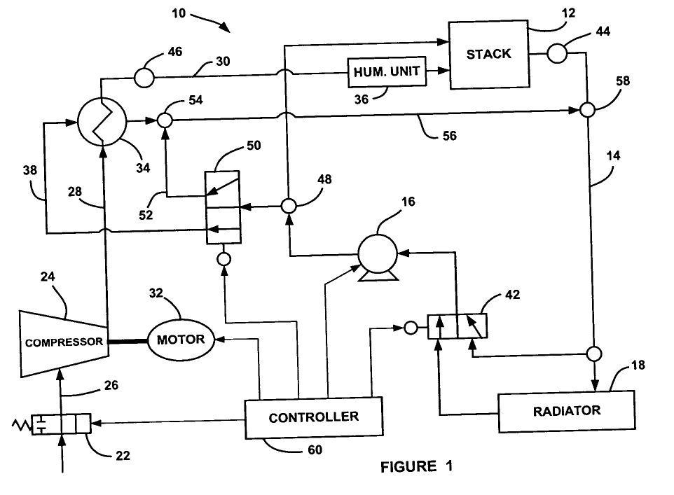

FIG. 1 is a schematic plan view of a fuel cell system 10 including a fuel cell stack 12. A cooling fluid flows through a coolant loop 14 and flow channels in the stack 12 to maintain the stack 12 at a desired operating temperature, such as between 60-80° C., to provide efficient stack operation. A pump 16 pumps the cooling fluid through the coolant loop 14, and a radiator 18 cools the cooling fluid in the coolant loop 14 to prevent the cooling fluid from becoming too hot, consistent with the discussion below. A compressor 24 receives air on an air input line 26 and provides compressed air on line 28 to be applied to the cathode input manifold of the stack 12 on input line 30. A motor 32 drives the compressor 24. An air inlet valve 22 is used to selectively allow air to flow to the compressor 24 to choke the compressor 24 during system start-up for reasons that will become apparent from the discussion below. A humidification unit 36 provides moisture in the compressed input air to help maintain the desired relative humidity of the fuel cell membranes within the stack 12. The stack relative humidity is also controlled by the stack pressure through, for example, a backpressure valve (not shown) in the cathode exhaust gas line.

The system 10 further includes a proportional by-pass valve 42 that selectively allows a portion of the cooling fluid to by-pass the radiator 18 when the temperature of the cooling fluid in the coolant loop 14 is below the desired operating temperature of the fuel cell stack 12. The system 10 also includes a temperature sensor 44 that measures the temperature of the cooling fluid in the loop 14 coming out of the stack 12 and a temperature sensor 46 that measures the temperature of the air going into the humidification unit 36 on the line 30.

Because compressing the air on the line 26 also significantly heats the air, the system 10 includes a heat exchanger 34 to cool the heated air before being applied to the line 30. Particularly, in a typical fuel cell system, the cathode input air is compressed to a pressure of about 2-3 bar, which also heats the air to about 140°-160° C. at maximum output. This temperature is too hot for the stack 12 and will damage the fuel cells in the stack 12. In order to address this concern, the system 10 directs a portion of the cooling fluid in the loop 14 to the heat exchanger 34 to cool the compressed air for efficient stack operation. Therefore, the cathode input air would be at the temperature of the cooling fluid, which could be quite low at system start-up. The heat exchanger 34 can be any liquid/gas heat exchanger suitable for the purposes discussed herein.

According to the invention, the fuel cell system 10 includes a proportional by-pass valve 50 that selectively directs the portion of the cooling fluid in the coolant loop 14 sent to the heat exchanger 34 through the heat exchanger 34 on a line 38 or to a line 52 that by-passes the heat exchanger 34. The cooling fluid sent through the heat exchanger 34 on the line 38 and the cooling fluid sent around the heat exchanger 34 on the line 52 are combined in a mixer 54. In this design, the cooling fluid in the loop 14 that is not sent to the heat exchanger 34 by a flow controller 48 is directed through the stack 12. The cooling fluid that is directed through the flow controller 48 to the heat exchanger 34 by-passes the stack 12 on line 56. The cooling fluid exiting the stack 12 is combined with the cooling fluid on the line 56 by a mixer 58.

At system start-up when the stack 12 is usually cold, the compressor 24 is started to compress the cathode input air, which provides heated air to the stack 12. Normally, a portion of the cooling fluid in the coolant loop 14, which is at the same temperature as the stack 12 at start-up, would be directed through the heat exchanger 34 to cool the cathode air before being applied to the stack 12. However, the proportional valve 50 can be used to selectively direct some of the cooling fluid 14 around the heat exchanger 34 so that the cathode input air on the line 30 is not cooled down all the way to the temperature of the cooling fluid. Therefore, the cathode input air will be heated some amount less than the temperature that would damage the fuel cells in the stack 12, but would more quickly heat the stack 12 at start-up than is currently available in the art. A controller 60 receives temperature signals from the temperature sensors 44 and 46, and controls the motor 32, the pump 16, the by-pass valve 42 and the by-pass valve 50 consistent with the discussion herein. It may be desirable to operate the speed of the pump 16 slowly at system start-up.

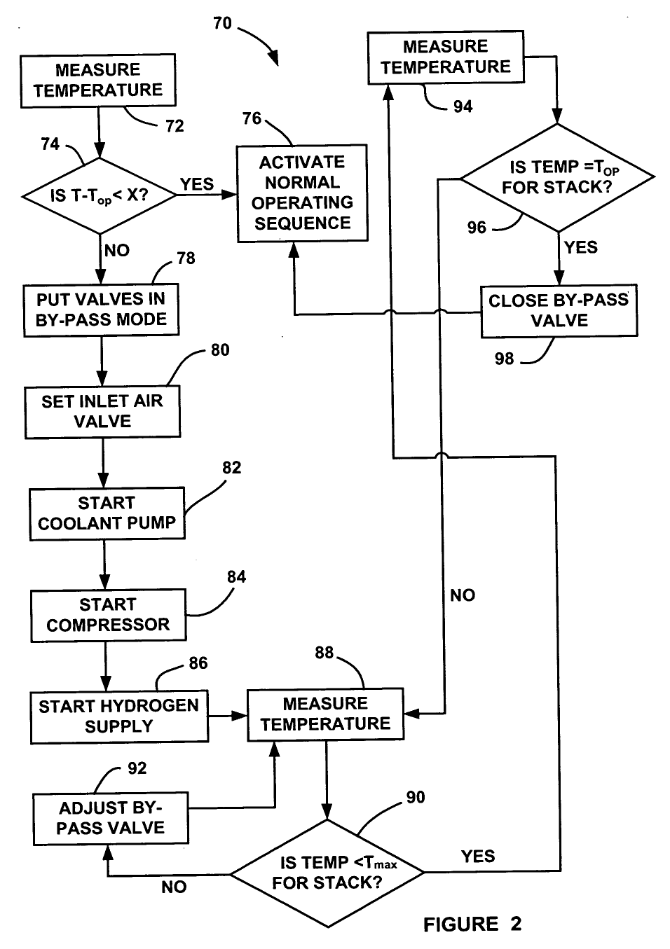

FIG. 2 is a flow chart diagram 70 showing the operation of the fuel cell system 10 for providing heated cathode input air at system start-up, according to one embodiment of the present invention. After the control algorithm is initialized, the algorithm measures the temperature of the cooling fluid exiting the stack 12 by the sensor 44 at box 72. The algorithm then determines whether the measured temperature of the cooling fluid out of the stack 12 minus a desired operating temperature of the cooling fluid out of the stack 12 is less than a predetermined value X defined by a minimum temperature difference to provide a fast enough start-up at decision diamond 74. Particularly, if the vehicle has not been off for a long enough time where the temperature of the stack 12 would be significantly reduced, then it is not necessary to heat the cathode input air to bring the stack 12 up to temperature quicker. If this temperature difference is less than the predetermined value X, then the algorithm would activate the normal operating sequence for a hot stack at box 76.

If the cooling fluid is too cool at start-up, then the algorithm puts the proportional valves 42 and 50 into their full by-pass mode at box 78. In the full by-pass mode, the proportional valve 50 is set so that a predetermined maximum amount of the cooling fluid will flow around the heat exchanger 34 on the line 52, and the proportional valve 42 is set so that a predetermined maximum amount of the cooling fluid in the cooling loop 14 will by-pass the radiator 18. Next, the algorithm sets the inlet air valve 22 to a predetermined choke position at box 80 that causes the compressor 24 to work harder to draw air through the valve 22, so that the compressed air is heated even more than it otherwise would be from the normal compression of the air, especially when the ambient air temperature is low. The algorithm then starts the pump 16 to pump the cooling fluid through the coolant loop 14 at box 82, starts the compressor 24 at box 84 and starts the hydrogen flow to the stack 12 at box 86.

The algorithm then measures the temperature of the cathode inlet air by the temperature sensor 46 at box 88. The algorithm determines whether the temperature of the cathode inlet air is less than the maximum safe temperature for the stack 12 at decision diamond 90. If the temperature of the cathode inlet air is not at the maximum safe stack temperature, then the algorithm adjusts the proportional valve 50 at box 92, and returns to measuring the cathode inlet air temperature at the box 88. Particularly, as the temperature of the cathode inlet air increases at system start-up, the controller 60 controls the position of the proportional valve 50 so that less of the cooling fluid by-passes the heat exchanger 34, so that the maximum temperature of the input air is not exceeded.

When the temperature of the cathode inlet air reaches the maximum safe temperature of the stack 12 at the decision diamond 90, then the algorithm measures the output temperature of the cooling fluid from the stack 12 by the temperature sensor 44 at box 94. The algorithm then determines whether the cooling fluid temperature is equal to the stack operating temperature at decision diamond 96. If the temperature of the cooling fluid out of the stack 12 is at the stack operating temperature, then the algorithm positions the by-pass valve 50 so that all of the cooling fluid from the flow controller 48 is sent through the heat exchanger 34, and continues with the regular operating sequence at the box 76. The position of the by-pass valve 42 is also set accordingly so that the temperature of the cooling fluid does not exceed the operating temperature of the stack 12. If the temperature of the cooling fluid out of the stack 12 is not at the stack operating temperature, then the algorithm returns to the box 88 to measure the temperature of the cathode inlet air.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A fuel cell system comprising:
a fuel cell stack including a cathode side, said cathode side being responsive to a cathode input flow;
a coolant loop for directing a cooling fluid through the fuel cell stack to control the temperature of the stack;
a heat exchanger responsive to the cathode input flow before the fuel cell stack, said heat exchanger receiving at least a portion of the cooling fluid for cooling the cathode input flow;
a first temperature sensor for measuring the temperature of the cooling fluid; and
a first by-pass valve for selectively directing the cooling fluid around the heat exchanger or through the heat exchanger depending on the temperature of the cooling fluid.

2. The fuel cell system according to claim 1 further comprising a compressor for compressing the cathode input flow, said heat exchanger being positioned between the compressor and the fuel cell stack.

3. The fuel cell system according to claim 1 further comprising a cathode inlet flow valve, said cathode inlet flow valve be selectively opened and closed to choke the compressor.

4. The fuel cell system according to claim 1 further comprising a second temperature sensor for measuring the temperature of the cathode input flow between the heat exchanger and the fuel cell stack, wherein the temperature of the cathode input flow also is used to control the first by-pass valve for selectively directing the cooling fluid around the heat exchanger or through the heat exchanger.

5. The fuel cell system according to claim 1 wherein the coolant loop is configured so that the cooling fluid flowing through the heat exchanger or directed around the heat exchanger by the first by-pass valve by-passes the fuel cell stack.

6. The fuel cell system according to claim 1 wherein the first by-pass valve is a proportional valve.

7. The fuel cell system according to claim 1 further comprising a radiator and a second by-pass valve, wherein the second by-pass valve selectively directs the cooling fluid around the radiator depending on the temperature of the cooling fluid.

8. The fuel cell system according to claim 1 wherein the first by-pass valve directs all of the cooling fluid received by the first by-pass valve through the heat exchanger if the temperature of the cooling fluid is at an operating temperature of the fuel cell stack.

9. The fuel cell system according to claim 1 wherein the fuel cell system is on a vehicle.

10. A fuel cell system comprising:
a compressor for compressing an air flow;
a fuel cell stack including a cathode side, said cathode side being responsive to a compressed air flow;
a coolant loop for directing a cooling fluid through the fuel cell stack to control the temperature of the stack;
a radiator for receiving the cooling fluid and cooling the cooling fluid to a predetermined temperature;
a heat exchanger responsive to the compressed air flow before the fuel cell stack, said heat exchanger receiving at least a portion of the cooling fluid for cooling the compressed air flow;
a first temperature sensor for measuring the temperature of the cooling fluid;
a second temperature sensor for measuring the temperature of the compressed air flow between the heat exchanger and the fuel cell stack; and
a first proportional by-pass valve for selectively directing the cooling fluid around the heat exchanger or through the heat exchanger depending on the temperature of the cooling fluid and the temperature of the compressed air flow.

11. The fuel cell system according to claim 10 further comprising a cathode inlet flow valve, said cathode inlet flow valve be selectively opened and closed to choke the compressor.

12. The fuel cell system according to claim 10 wherein the coolant loop is configured so that the cooling fluid flowing through the heat exchanger or directed around the heat exchanger by the first by-pass valve by-passes the fuel cell stack.

13. The fuel cell system according to claim 10 further comprising a second proportional by-pass valve for selectively directing the cooling fluid around the radiator depending on the temperature of the cooling fluid.

14. The fuel cell according to claim 10 wherein the first by-pass valve directs all of the cooling fluid received by the first by-pass valve through the heat exchanger if the temperature of the cooling fluid is at an operating temperature of the fuel cell stack.

15. The fuel cell system according to claim 10 wherein the fuel cell system is on a vehicle.

16. A method for heating a fuel cell stack in a fuel cell system, said method comprising:
directing a cathode input flow to the fuel cell stack;
directing a cooling fluid through the fuel cell stack to control the temperature of the stack;
using at least a portion of the cooling fluid for cooling the cathode input flow in a heat exchanger;
measuring the temperature of the cooling fluid; and
selectively directing the cooling fluid around the heat exchanger or through the heat exchanger depending on the temperature of the cooling fluid.

17. The method according to claim 16 further comprising selectively opening and closing a cathode input flow valve for choking the compressor.

18. The method according to claim 16 further comprising measuring the temperature of the cathode input flow between the heat exchanger and the fuel cell stack, wherein the temperature of the cathode input flow also is used for selectively directing the cooling fluid around the heat exchanger or through the heat exchanger.

19. The method according to claim 16 further comprising selectively directing the cooling fluid around a radiator depending on the temperature of the cooling fluid.

20. The method according to claim 16 wherein selectively directing the cooling fluid around the heat exchanger or through the heat exchanger includes directing all of the cooling fluid received by the first by-pass valve through the heat exchanger if the temperature of the cooling fluid is at an operating temperature of the fuel cell stack.
